(19) United States
(12) Patent Application Publication
(10) Pub. No.: US 2005/0061316 A1
(43) Pub. Date: Mar. 24, 2005

(54) Air curtain device with flexible shield

(76) Inventor: Joseph Manne, New York, NY (US)

Correspondence Address: MUSERLIAN, LUCAS AND MERCANTI, LLP, 475 PARK AVENUE SOUTH, 15TH FLOOR, NEW YORK, NY, 10016, US

(21) Appl. No.: 10/869,526

(22) Filed: Jun. 14, 2004

Related U.S. Application Data
(63) Continuation-in-part of application No. 10/408,685, filed on Apr. 7, 2003.
(60) Provisional application No. 60/370,880, filed on Apr. 8, 2002.

(51) Int. Cl. A62B 18/00

(52) U.S. Cl. 128/200.27; 128/200.28; 128/863

(57) ABSTRACT

The device creates a shield around the nose and mouth of a user and a flow of air through the shield. The flow of air through the shield prevents airborne particles and chemicals from making contact with the face.

### CROSS REFERENCE TO RELATED APPLICATIONS

This Application is a Continuation-in-part of U.S. application Ser. No. 10/408,685, filed Apr. 7, 2003 which, in turn, claims the priority of U.S. Provisional Patent Application No. 60/370,880, filed Apr. 8, 2002.

### BACKGROUND OF THE INVENTION

1. Field of the Invention

This Invention relates to a device for shielding the face of a human from airborne particles.

2. Art Related to the Invention

Airborne particles which float on the currents of air are well known. Typically, such airborne particles are referred to as odors or smoke. Airborne particles can also include microbes such as allergens, viruses and bacteria which cause diseases. For example, bacteria may cause tuberculosis and Anthrax which is typically carried in the air.

Conventionally, a mask is worn to shield the face and prevent these airborne particles and/or chemicals from making contact with the face of a human. Such face masks generally cover the entire face to include the nose, mouth and eyes. These face masks have a drawback and are often difficult to put on and restrictive to the wearer. There is a need for a simple device to protect the face and prevent the nose and mouth from such airborne particles.

### SUMMARY OF THE INVENTION

A device has now been discovered which can protect the nose and mouth of a user from airborne particles and chemicals. The device of the present Invention is simple to wear and does not restrict the user while it is being worn.

Broadly, the present Invention is a portable device worn by a human user for shielding their nose and mouth from airborne materials. The device comprises:
(a) a support means adapted to be worn by the user on its head, neck, shoulders or chest;
(b) a flexible shield means which extends outwardly from, and is perpendicular to, the face of the user. This shield means is affixed to the support means; and
(c) an airflow means for generating and directed a flow of air from the face of the user outwardly along the shield means such that the airflow blows airborne materials which are carried by the air current away from the face.

The flexible shield means is suitably compressable tubing which can extend outwardly or be pushed back depending on length that is necessary to shield the face. Alternatively, the shield means could be a flexible bag which already extends out.

The shield means could also be a plurality of movable plates than can be unfolded to form a tube.

In any one of these shield means, the end of the shield, that portion of the shield which is farthest away from the face, can be flexible in order to allow it to close down the opening. In any event, however, it must never close down completely since there must be an outlet for which the air can extend.

The other end of the shield means, that portion which is against the face, should mate with the face and form a seal with the face so as to prevent airborne particles from entering between the face and the shield.

In the shield means that have a plurality of plates that mate together, these plates can be interconnected or can be individual provided that each plate mates with its adjoining plate.

The support means of the present Invention include a hat, a headset, a shoulder harness switch, a chest harness, all of which are conventional pieces and provide support for the other two pieces, namely, the shield and the airflow means.

The airflow means is suitably a fan with a power source and tubing so as to direct the airflow to the shield means. Alternatively, the airflow means could be a canister of compressed air with tubing to direct the air to the shield.

The device of the present Invention can further include a detector which is mounted on a portion of the support or portion of the shield or the airflow means for detecting airborne materials. Such detecting means can be connected to an alarm cord so that the user is alerted to the fact that he is entering an area with airborne particles that should be prevented from making contact with the face.

It is also preferred that the device have an air conditioning unit, such as a dehumidifier, a humidifier, an irradiating source or a fragrant source, so that the air that is traveling to the device is treated.

Preferably, a filter is associated with the airflow means when the airflow means is a fan so as to prevent the intake of the fan from acquiring airborne materials.

### BRIEF DESCRIPTION OF THE DRAWINGS

These and other aspects of the present Invention may be more fully understood by reference to one or more of the following drawings:

FIG. 1 is a top view of a human wearing the device of the present Invention wherein the shield is expandable tubing;

FIG. 2 is a front view of FIG. 1;

FIG. 3 is a top view of the present Invention showing a detector and a shield wherein the shield is a bag;

FIG. 4 is a top view of the device with a detector and a shield of compressible tubing;

FIG. 5 is a side view of the preferable air fan used in the present Invention;

FIG. 6 is a side view of human wearing the device of the present Invention wherein the fan is mounted on a belt;

FIG. 7 is a top view of the device of the present Invention wherein the shield is of flexible plates;

FIG. 8 is a front view of the device of the present Invention employing flexible plates which have been folded up; and

FIG. 9 shows the flexible plates of FIG. 8 which have been unfolded to form a complete tube.

### DETAILED DESCRIPTION OF THE INVENTION

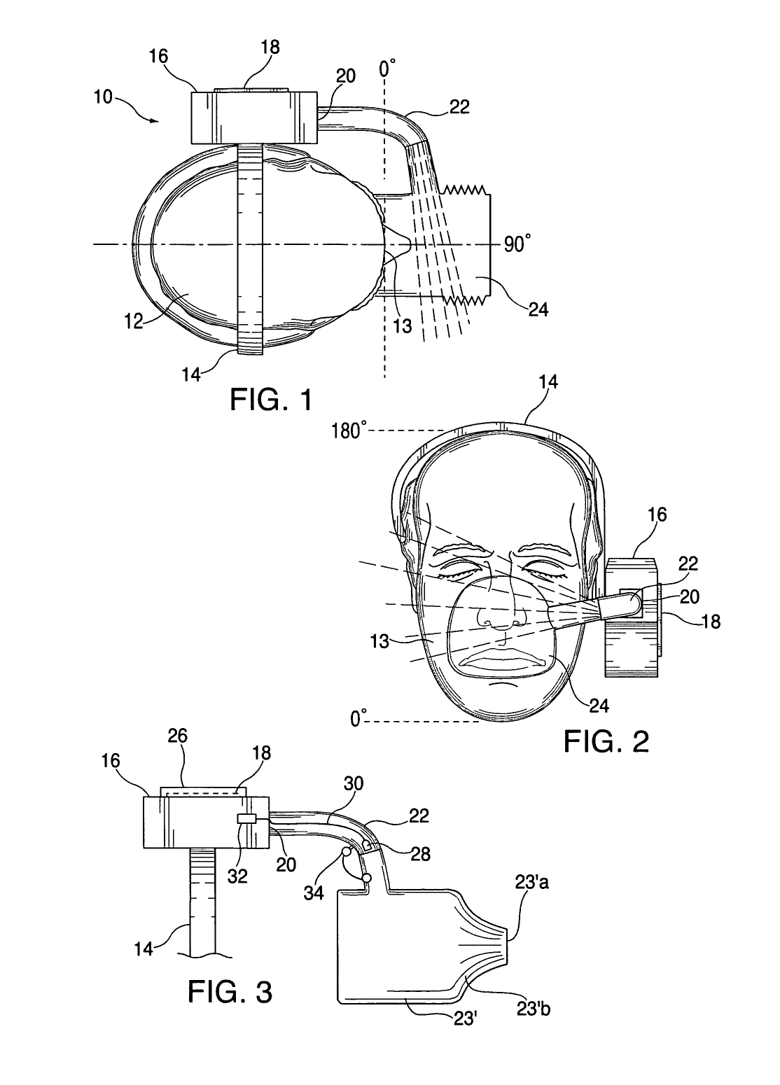

Turning to FIG. 1, the device of the present Invention is worn on head 12 of a human being. Device 10 comprises a headset 14 to which is mounted a fan 16. Fan 16 has inlet 18 and outlet 20. Fixed outlet 20 is flexible tubing 22 which extends around to shield 23. Shield 23 is shown as expandable tubing. Outlet 20 has a manifold to mate to tubing 22. Fan 16 with tubing 22 generates a curtain of air into the channel created by tubing 23 such that the air moves from face 13 outward therefrom.

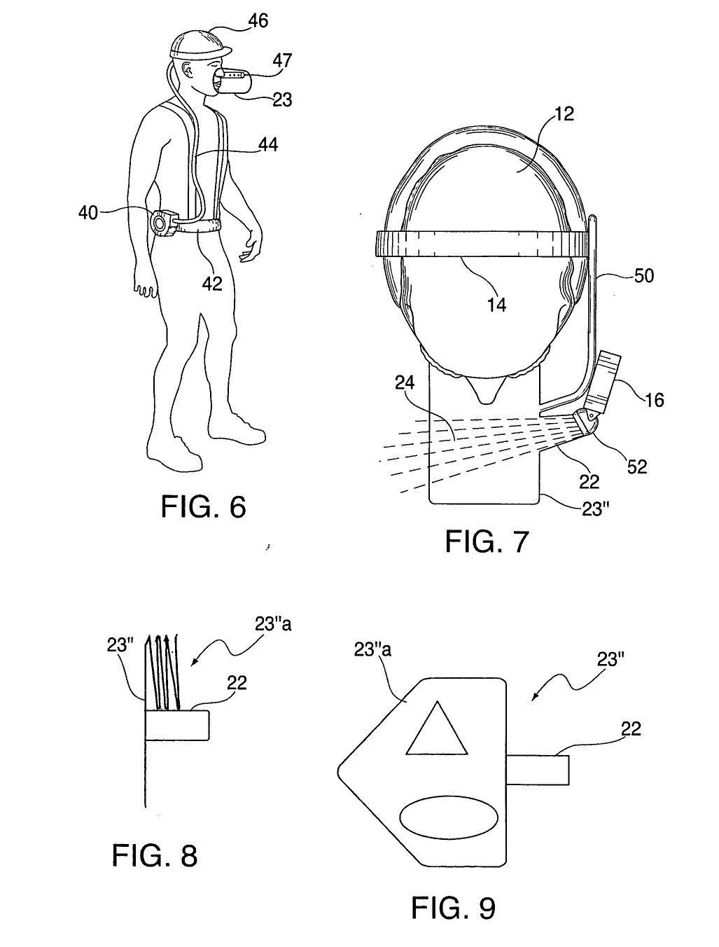

Flexible tubing 23 can extend outward so as to create an expanded tube such as is shown in FIG. 6.

FIG. 2 is a front view of face 13 showing the device. In both devices, air curtain 24 is shown blowing outward from the face through tubing 23.

In FIG. 3, filter 26 is shown covering inlet 18 of fan 16. A detector 28 is positioned on tubing 22. Detector 28 is connected by wire 30 to alarm 32. Also, as shown in FIG. 3, air conditioning device 34 is depicted. In this case, air conditioning device 34 is a humidifier which adds moisture to airflow 24 as it passes through tubing 22 and into shield 23′. Shield 23′, as depicted in FIG. 3, is a bag which at its open end of 23′a has compressible ridges which allow for opening compressible ridges 23′b which allow opening 23′a to be shut down to a small size. Opening 23′a cannot be closed permanently and has to be open to a certain degree to allow the air to pass outward through it. As shown in FIG. 3, and 23 has been shut down.

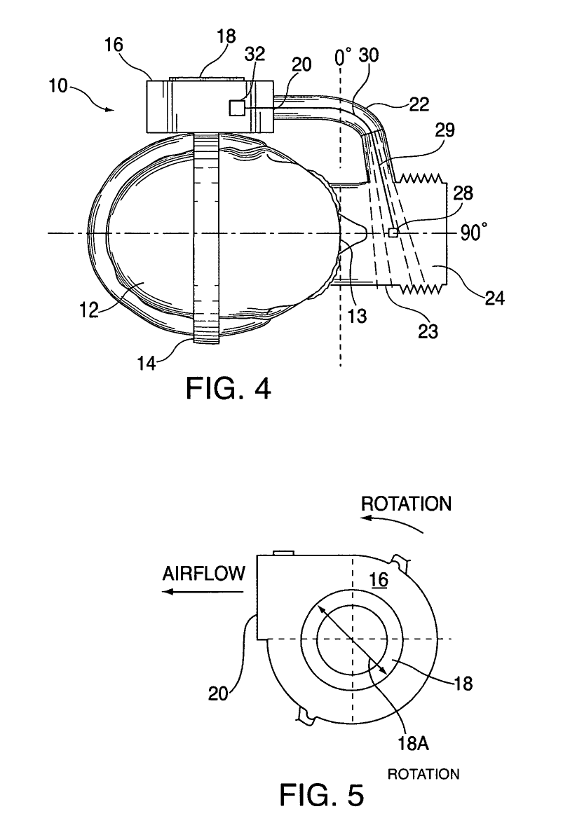

FIG. 4 illustrates detector 28 extending outward into pool 23 by means of stiff wire 29.

FIG. 5 details a preferred fan for use in the present Invention. It will be appreciated that other types of fans can be employed. Such fans are generally electrical in nature and employ a battery which can be either connected directly to the fan or worn as a separate portion and connected to a fan by wires. Fan 16 is essentially a square having dimensions of about 3″ by 3″, inlet diameter 18a of about 2″. Outlet 20 of fan 16 is rectangular in shape and measures about 1″ in width and 1 ½ in height. Fan 16 operates under a current suitably 12 volts and has a housing made of plastic thereby making it light in weight.

The airborne materials which are intended to be prevented from making contact with the nose and mouth by means of the present Invention include odors, smoke particles, allergens, airborne microbes such as viruses and bacteria. Additionally, spores are prevented. Two primarily airborne microbes and viruses that must be prevented from making contact with human beings are tuberculosis and Anthrax.

The current of air, which is redirected through the shield, has a velocity such that it blows particles away from the nose and mouth of the user.

Alarm 32 is preferably an audio alarm but can also include a visual light. Such a light would then alert the user of airborne particles in the area to turn on the fan.

Alarm 32 can also include a microprocessor which increases or turns on the fan automatically to start the flow-of air through the device.

FIG. 6 of the present Invention shows fan 41 on belt 42. Tubing 44 directs the air from the outlet of fan 40 up and to the shield 23. Headgear 46 acts as a point of attachment for tubing 44 and shield 23. Tube 44 makes contact at point 47 with shield 23.

In FIG. 7, headset 14 is worn on the head of the user and beam 50 is affixed to the headset at one end and fan 16 is affixed to the other end of boom 50. Boom 50 also continues to extend out and is connected to shield 23′′. From outlet 52 of fan 16 is connected tubing 22 which connects to shield 23′. Shield 23′ is a set of folding plates which can be extended outward to form a complete shield. When these tubes are folded up, a single wall is formed and, as shown in FIG. 7, the air travels across the face rather than down.

In FIG. 8, front view of shield 23″ is shown. The main plate of shield 20 is connected to a number of smaller plates 23″a which can be extended outward, as shown in FIG. 9, so as to create a full tube which encloses the nose and mouth of the user as shown.

As will be understood, the plates 23″a, as shown in FIG. 8, are interconnected. These plates can also be individual and matable so that they can be connected up to form the unit as shown in FIG. 9. In order to mate such plates, Velcro attachments can be employed or other similar adhesive type devices.

The rest of the present Invention is intended to be used by people with allergies, hayfever, people who want to breathe purified or clean air, people who don't want to breathe in cigarettes, cigar or pipe smoke, people who want to avoid objectionable odors, people who want to avoid contaminants from the work place area which include airborne illnesses and doctors working in hospitals and persons working in dangerous airborne chemical areas.

It will be understood that the claims are intended to cover all changes and modifications of the present Invention herein shown for the purposes of illustration which do not constitute a departure from the spirit or scope of the Invention.

1. A portable device worn by a human user for shielding a nose and mouth of a user from airborne materials comprising:
(a) a support means adapted to be worn by a user on head, neck or shoulder;
(b) a flexible shield means which extends outward from, and is perpendicular to, a face of said user, said shield means affixed to said support; and
(c) an airflow means for generating and directing an airflow from said face outward and along said shield means, said airflow means affixed to said support thereby making said device portable.

2. The device of claim 1, wherein said shield means is compressible tubing.

3. The device of claim 1, wherein said shield is a bag.

4. The device of claim 1, wherein said shield comprises a plurality of matable plates that unfold to form a tube.

5. The device of claim 4, wherein each of said plates is detachable from an adjacent plate.

6. The device of claim 4, wherein each of said plates is movably fixed to an adjacent plate.

7. The device of claim 1, wherein said support means is selected from the group consisting of a hat, a headset, a shoulder harness or a chest harness.

8. The device of claim 1, wherein said airflow means is a fan with a power source and tubing to direct the air or a canister of compressed air with tubing to direct the air.

9. The device of claim 1, further comprising: a detector mounted on said support for detection of airborne materials.

10. The device of claim 1, further comprising: an air conditioning device for conditioning the air exiting from said airflow means.
